(19) United States
(12) Patent Application Publication
(10) Pub. No.: US 2022/0281447 A1
(43) Pub. Date: Sep. 8, 2022

(54) VEHICLE DRIVING SYSTEM AND CONTROL METHOD PERFORMED BY VEHICLE DRIVING SYSTEM

(71) Applicant: HYUNDAI MOBIS Co., Ltd., Seoul (KR)

(72) Inventors: Tae Min KWON, Seosan-si (KR); Min Seok KIM, Seosan-si (KR)

(73) Assignee: HYUNDAI MOBIS Co., Ltd., Seoul (KR)

(21) Appl. No.: 17/687,314

(22) Filed: Mar. 4, 2022

(30) Foreign Application Priority Data
Mar. 8, 2021 (KR) 10-2021-0030093

(51) Int. Cl. B60W 30/095; B60W 60/00

(52) U.S. Cl. CPC B60W 30/0956; B60W 30/0953; B60W 60/001; B60W 2554/4049; B60W 2554/4041

(57) ABSTRACT

A vehicle driving system enabling safe traveling on a narrow road and a method performed by the vehicle driving system for controlling a vehicle are disclosed. The vehicle driving system includes a sensor configured to monitor an environment outside a vehicle and a controller. The controller is configured to recognize an oncoming traveling object through the sensor, derive a width of a travelable road between the traveling object and the vehicle, determine priority between the traveling object and the vehicle when the width of the travelable road is smaller than a sum of widths of the traveling object and the vehicle, and, when the traveling object is determined to have the priority, control traveling of the vehicle to provide a space in a lateral direction of the vehicle to allow the traveling object to pass.

### CROSS-REFERENCE TO RELATED APPLICATION(S)

This application is based on and claims priority under 35 U.S.C. 119 to Korean Patent Application No. 10-2021-0030093, filed on Mar. 8, 2021, in the Korean Intellectual Property Office, the disclosure of which is herein incorporated by reference in its entirety.

### BACKGROUND OF THE INVENTION

### 1. Field of the Invention

The present disclosure relates to a system for enabling an autonomous vehicle to travel in narrow alleys and a method for controlling the same and, more specifically, to a vehicle driving system configured such that, when there is a traveling object traveling in the opposite direction in a narrow alley, the vehicle is driven safely so as not to collide with the traveling object, and even an inexperienced driver is enabled to travel safely in a congested alley crowded with parked vehicles or obstacles.

### 2. Description of the Prior Art

There has recently been ongoing development regarding autonomous driving technologies for minimizing driver intervention, including ADAS systems for assisting drivers' driving. Autonomous driving technologies have a problem in that the same are easy to implement if the driving environment can be clearly recognized, and if there is sufficient peripheral space (for example, in the case of wide roads having clearly defined lanes), but the same are implemented in a limited manner in the case of narrow roads (for example, alleys), requiring manual manipulation by the drivers, and inexperienced drivers who have insufficient judgement regarding vehicle widths cause accidents frequently.

### SUMMARY OF THE INVENTION

The present disclosure has been proposed to solve the above-mentioned problems, and it is an aspect of the present disclosure to provide a vehicle driving system configured to recognize an oncoming traveling object in a congested narrow road and to safely drive the vehicle while avoiding the same.

In accordance with an aspect of the present disclosure, a vehicle driving system may include: a sensor configured to monitor an environment outside a vehicle; and a controller configured to recognize an oncoming traveling object through the sensor, derive the width of a travelable road between the traveling object and the vehicle, determine priority between the traveling object and the vehicle when the width of the travelable road is smaller than the sum of widths of the traveling object and the vehicle, and, when the traveling object is determined to have the priority, control traveling of the vehicle to provide a space in a lateral direction of the vehicle to allow the traveling object to pass.

The controller may derive an expected collision site of the vehicle and the traveling object, and may determine that one of the vehicle and the traveling object, which requires a less time to reach the expected collision site, has the priority.

The controller may derive a time to collision (TTC) between the vehicle and the traveling object, and, when the TTC is less than a reference value, may determine that one of the vehicle and the traveling object, which has a higher speed or higher acceleration, has the priority.

The controller may derive an expected collision site of the vehicle and the traveling object, and may determine that one of the vehicle and the traveling object, which first passes through one of two sites spaced a predetermined distance apart from the expected collision site and facing each other, has the priority.

The controller may determine that the traveling object has priority when the traveling object is recognized as having an intention to travel.

When the traveling object does not decelerate, the controller may recognize the traveling object as having an intention to travel.

When the rate of change in a forward heading angle of the traveling object is less than a reference value, the controller may recognize the traveling object as having an intention to travel.

When the traveling object does not make way for a predetermined time in a situation in which the vehicle and the traveling object stop, the controller may recognize the traveling object as having an intention to travel.

A method performed by a vehicle driving system for controlling a vehicle may include: recognizing, by a sensor, an oncoming traveling object through a sensor; deriving, by a controller, the width of a travelable road between the traveling object and a vehicle; determining, by the controller, priority between the traveling object and the vehicle when the width of the travelable road is smaller than the sum of widths of the traveling object and the vehicle; and controlling, by the controller, when the traveling object is determined to have the priority, traveling of the vehicle to provide a space in a lateral direction of the vehicle to allow the traveling object to pass.

In the determining of priority, an expected collision site of the vehicle and the traveling object may be derived, and one of the vehicle and the traveling object, which requires a less time to reach the expected collision site, may be determined to have the priority.

After the determining of priority, the method may further include determining, by a controller, whether the traveling object has an intention to travel, and, the traveling object may be determined to have the priority when the traveling object is recognized as having an intention to travel.

The present disclosure is advantageous in that it is possible to travel on a narrow road regardless of whether the same has lanes or not, and even if there are obstacles (for example, parked vehicles) on the narrow road, it is possible to safely travel while avoiding the same. In addition, even an inexperienced driver can safely travel in a narrow and congested road environment.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates a configuration of a vehicle driving system of the present disclosure;

FIGS. 2 to 9 are views provided for helping to understand the present disclosure; and

FIG. 10 is a flowchart illustrating a system control method of the present disclosure.

### DETAILED DESCRIPTION OF THE EXEMPLARY EMBODIMENTS

Hereinafter, the present disclosure will be described in detail.

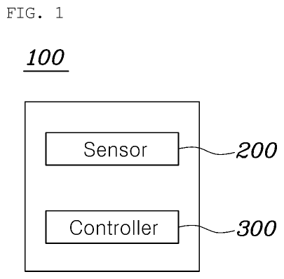

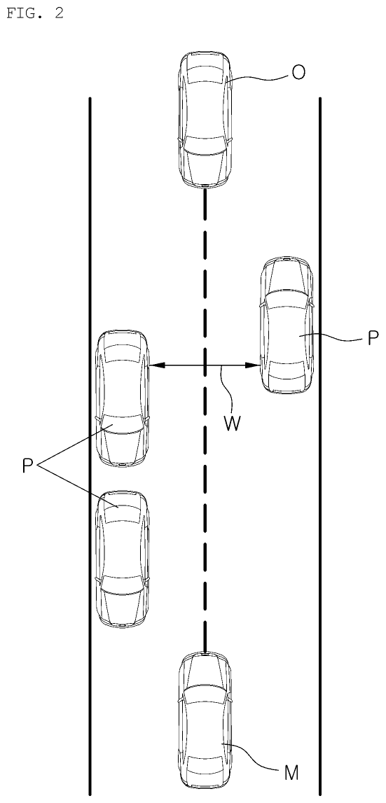

FIG. 1 illustrates a configuration of a vehicle driving system 100 of the present disclosure. The vehicle driving system according to the present disclosure includes: a sensor 200 configured to monitor an environment outside a vehicle; and a controller 300 configured to recognize an oncoming traveling object through the sensor 200, derive the width of a travelable road between the traveling object and the vehicle, determine priority between the traveling object and the vehicle when the width of the travelable road is smaller than the sum of the widths of the traveling object and the vehicle, and, when it is determined that the traveling object has priority, control traveling of the vehicle such that a space through which the traveling object can pass is ensured in the lateral direction of the vehicle.

Specifically, the present disclosure relates to a traveling system for controlling traveling of a vehicle on a narrow road, in particular, a narrow road on which two vehicles traveling in different directions cannot simultaneously travel due to parked vehicles or other obstacles on the narrow road.

The sensor 200 (e.g., an ultrasonic sensor, a radar, a LiDAR, a camera, etc.), which is an element for the system, monitors an environment outside the vehicle. Specifically, the sensor 200 may monitor whether there is a traveling object (e.g., an oncoming vehicle, a bicycle, etc.) in front of the vehicle, whether there is a lane around the vehicle, or whether there is an obstacle (e.g., a parked or stopped vehicle, etc.) around the vehicle.

When it is determined, based on the outside environment by the sensor 200, that there is a traveling object in front of the vehicle, the controller 300 sums the transverse width of the traveling object in front of the vehicle and the transverse width of the vehicle, compares the sum with the transverse width of a travelable road, and then determines priority regarding which of the traveling object and the vehicle can first pass through the travelable road.

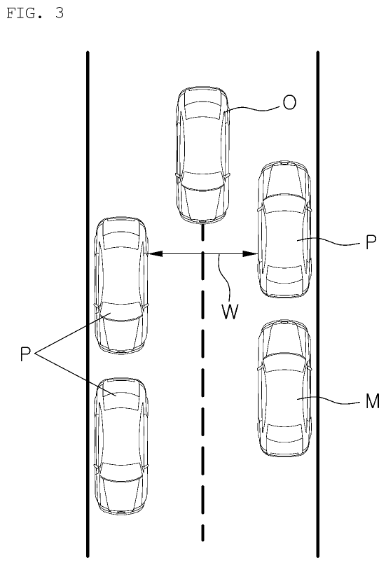

FIG. 2 is a view provided for helping to understand the present disclosure. Three parked or stopped vehicles P are on a road, and a traveling object O and a vehicle M have different traveling directions. The traveling object O and the vehicle M need to travel while passing through a space between the parked or stopped vehicles, and the space between the parked or stopped vehicles becomes a travelable road. Since the traveling object has been recognized by the sensor 200, the controller 300 sums the transverse width of the traveling object O and the transverse width of the vehicle M, and then compares the sum with the width W of the travelable road. In FIG. 2, the width W of the travelable road is smaller than the sum of the transverse widths of the traveling object O and the vehicle M, and thus the traveling object and the vehicle cannot simultaneously travel on the travelable road. Therefore, subsequently, the controller 300 prioritizes the traveling object O and the vehicle M to determine which of the traveling object O and the vehicle M is given priority to travel on the travelable road and which of the traveling object O and the vehicle M needs to yield. For example, when the traveling object O is determined to have priority, the controller 300 may control traveling of the vehicle M to provide a space such that the traveling object O can safely pass by the vehicle M.

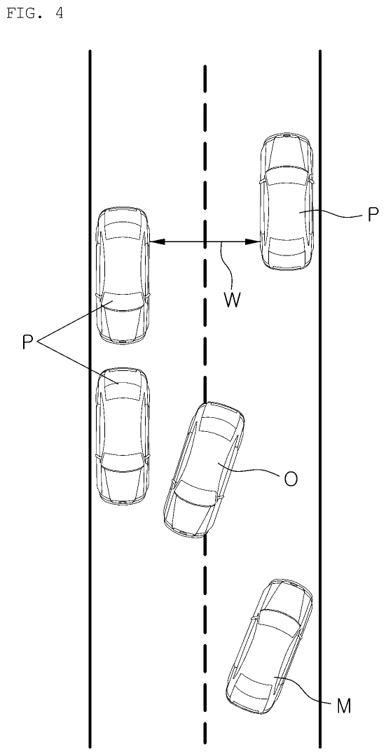

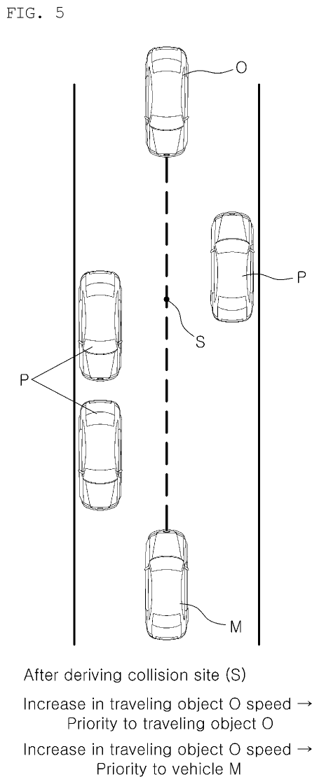

At this time, the vehicle M may be controlled to make way for the traveling object O, and, for example, as illustrated in FIGS. 3 and 4, may be controlled to provide a traveling space to the traveling object O.

Specific control to determine which of the vehicle M and the traveling object O has priority is as follows.

The controller 300 may derive an expected collision site (S) of the vehicle M and the traveling object O, and may determine that one of the vehicle M and the traveling object O, which requires a less time to reach the expected collision site (S), has priority over the other.

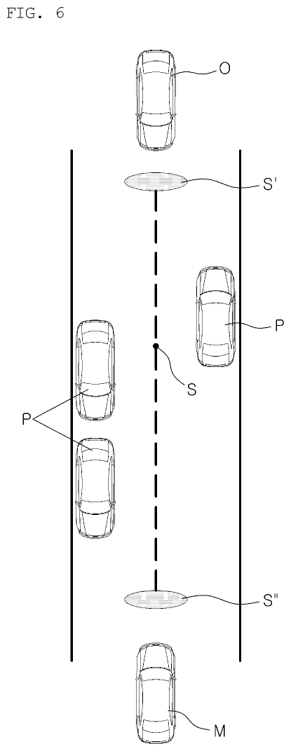

Specifically, the controller 300 may derive the expected collision site (S) through the speeds of the vehicle M and the traveling object O and the distance therebetween. When the collision site (S) is derived, the controller 300 fixes the collision site, and determines which of the vehicle M and the traveling object O will reach the collision site (S) first, that is, which of the vehicle M and the traveling object O requires a less time to reach the collision site (S). For example, referring to FIG. 5, after the collision site (S) is derived, when the speed of the vehicle M is not changed and when the speed of the traveling object O increases, the traveling object O first reaches the collision site (S). Therefore, it is determined that the traveling object O has priority. On the contrary, after the collision site (S) is derived, when the speed of the vehicle M is not changed and when the speed of the traveling object O decreases, the vehicle M first reaches the collision site (S). Therefore, it is determined that the vehicle M has priority.

The controller 300 may derive a time to collision (TTC) between the vehicle M and the traveling object O, and when the TTC is less than a reference value, may determine that one of the vehicle M and the traveling object O, which has a higher speed or higher acceleration, has priority.

Specifically, the controller 300 may derive an expected collision time, that is, the time that remains until collision therebetween, through the speeds of the vehicle M and the traveling object O and the distance therebetween. At this time, the controller 300 derives a TTC, and then, when the TTC is less than the reference value, may determine that the vehicle M and the traveling object O are in danger of colliding with each other on a travelable road, and may determine that one of the vehicle M and the traveling object O, which has a higher speed or higher acceleration, has priority. If the TTC is greater than the reference value, much time remains until collision, and thus the vehicle M and the traveling object O are considered to have a much time to avoid each other, whereby the vehicle M may speed up and first pass through travelable road.

The controller 300 may derive an expected collision site (S) of the vehicle M and the traveling object O, and may determine that one of the vehicle M and the traveling object O, which first passes through any one of two sites (S′) spaced a predetermined distance apart from the expected collision site (S) and facing each other, has priority.

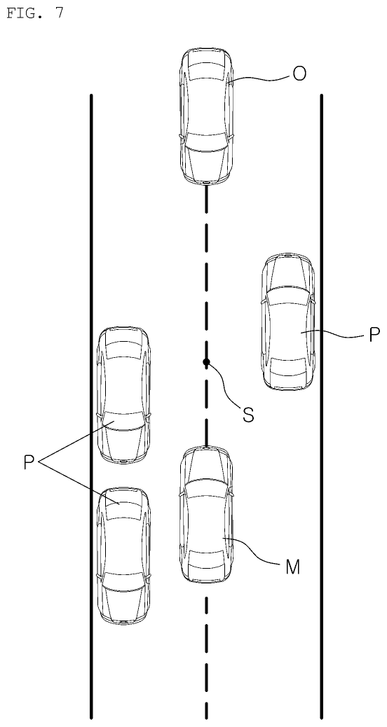

Specifically, referring to FIG. 6, the controller 300 may derive an expected collision site (S) through the speeds of the vehicle M and the traveling object O and the distance therebetween. When the collision site (S) is derived, the controller 300 may fix the collision site (S), may configure two imaginary sites (S′) spaced the same distance apart from the collision site (S) interposed therebetween, and may determine that one of the vehicle M and the traveling object O, which first passes through any one of the two sites (S′), has priority. For example, when the traveling object O first passes through an imaginary site (S′), the traveling object O has priority, and when the vehicle M first passes through an imaginary site (S′), the vehicle M has priority.

When the traveling object O is recognized as having an intention to travel, the controller 300 may determine that the traveling object O has priority.

When the vehicle driving system 100 of the present disclosure is included in both the vehicle M and the traveling object O, the vehicle M and the traveling object O can travel on a narrow road even under the above condition. However, if the traveling object O does not include the vehicle driving system 100, even when it is determined that the vehicle M has priority, the vehicle M and the traveling object O are in danger of colliding with each other provided that the traveling object O has an intention to travel. Thus, in this case, the traveling object O may be considered to have priority.

Specifically, when the traveling object O does not decelerate, the controller 300 may recognize the traveling object O as having an intention to travel. Referring to FIG. 7, in a situation in which the vehicle M has been determined to have priority, when the traveling object O does not decelerate, the controller 300 may consider the traveling object O to have an intention to travel, and may re-determine that the traveling object O has priority.

Further, when the rate of change in a forward heading angle of the traveling object O is less than a reference value, the controller 300 may recognize the traveling object O as having an intention to travel.

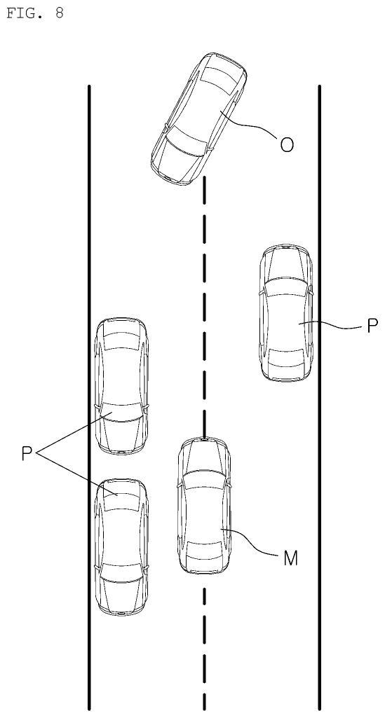

Specifically, referring to FIG. 8, in the situation in which the vehicle M has been determined to have priority, the traveling object O needs to change the traveling direction thereof in order to avoid the vehicle. Therefore, if the traveling object O has an intention to yield, the heading angle is changed as illustrated in FIG. 8A. However, if the traveling object O has no intention to yield, the heading angle is not changed even while the traveling object O travels. Therefore, when the rate of change in the heading angle of the traveling object O is less than the reference value, the controller 300 may re-determine that the traveling object O has an intention to travel and the traveling object O has priority.

In a situation in which the vehicle M and the traveling object O stop, when the traveling object O does not make way for a predetermined time, the traveling object O may be recognized as having an intention to travel.

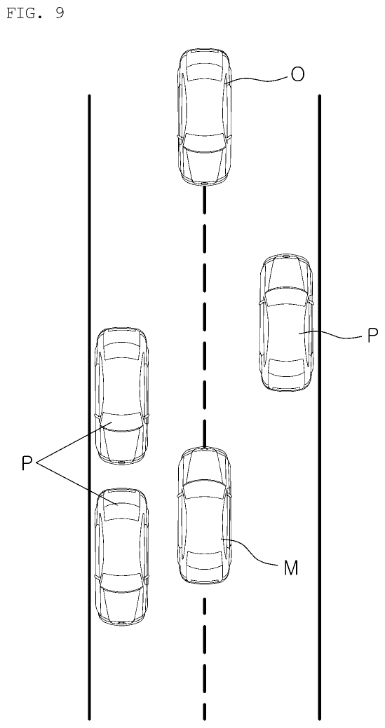

Specifically, referring to FIG. 9, in a situation in which the vehicle M has been determined to have priority, the traveling object O needs to yield to the vehicle such that the vehicle can pass. In a situation in which both the traveling object O and the vehicle M stop, the controller 300 controls the vehicle M such that the vehicle M stands by for a predetermined time. When the traveling object does not make way for a predetermined time, the controller 300 may determine that the traveling object O has an intention to travel, and may re-determine that the traveling object O has priority, whereby the vehicle M may travel backward on a traveling path to make way for the traveling object O.

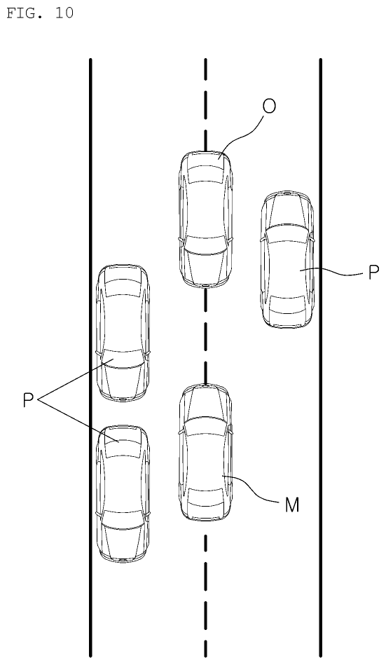

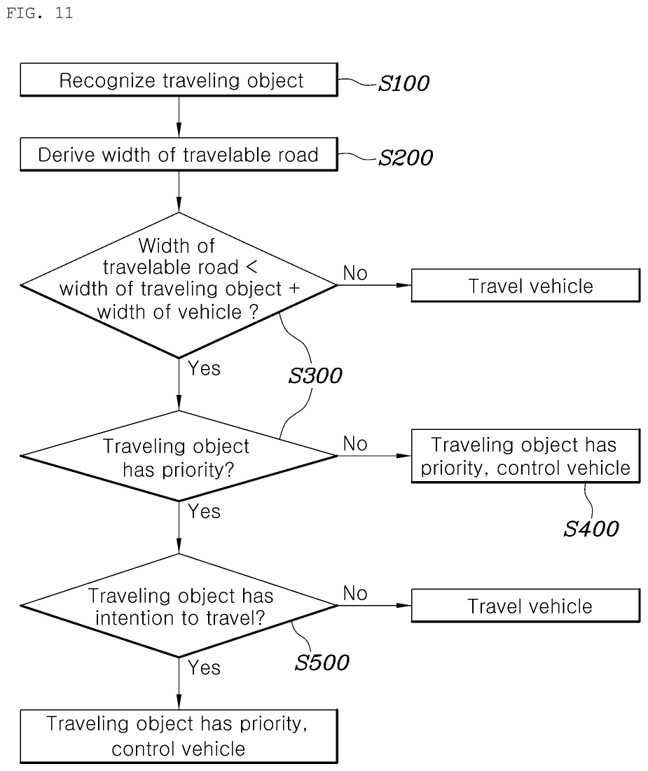

Referring to FIG. 10, a method for controlling the vehicle driving system includes: a step S100 of recognizing an oncoming traveling object through a sensor; a step S200 of deriving the width of a travelable road between the traveling object and a vehicle; a step of S300 of determining priority between the traveling object and the vehicle when the width of the travelable road is smaller than the sum of the widths of the traveling object and the vehicle; and a step S400 of controlling, when the traveling object is determined to have priority, traveling of the vehicle such that a space through which the traveling object can pass is ensured in the lateral direction of the vehicle.

In the step S300 of determining priority, an expected collision site of the vehicle and the traveling object may be derived, and one of the vehicle and the traveling object, which requires a less time to reach the expected collision site, may be determined to have priority.

For example, when the traveling object requires the less time to reach the expected collision site, the traveling object may be determined to have priority, and the traveling of the vehicle may be controlled such that the traveling object can pass through a travelable road. After the step S300 of determining priority, the method may further include a step S500 of determining whether the traveling object has an intention to travel, and it may be determined that the traveling object has priority when the traveling object is recognized as having an intention to travel.

For example, even when the vehicle has been determined to have priority, if the traveling object is determined to have an intention to travel, the traveling of the vehicle may be controlled such that the traveling object can first pass through the travelable road.

The controller 300 may include a processor or a microprocessor. Optionally, the controller 300 may also include a memory. The aforementioned operations/functions of the controller 300 can be embodied as computer readable code/algorithm/software stored on the memory thereof which may include a non-transitory computer readable recording medium. The non-transitory computer readable recording medium is any data storage device that can store data which can thereafter be read by the processor or the microprocessor. Examples of the computer readable recording medium include a hard disk drive (HDD), a solid state drive (SSD), a silicon disc drive (SDD), read-only memory (ROM), random-access memory (RAM), CD-ROM, magnetic tapes, floppy disks, optical data storage devices, etc. The processor or the microprocessor may perform the above described operations/functions of the controller 300, by executing the computer readable code/algorithm/software stored on the non-transitory computer readable recording medium.

According to a vehicle driving system and a method for controlling the same in the present disclosure, it is possible for an unskilled driver to easily pass through a narrow road and perform safe traveling even in a busy and narrow road environment. Further, when there is an oncoming traveling object, it is possible to travel while safely avoiding the same.

The present disclosure has been illustrated and described in relation to specific embodiments. However, it will be obvious to those skilled in the art that the present disclosure can be variously modified and changed without departing from the technical sprit of the present disclosure provided in the following claims.

What is claimed is:

1. A vehicle driving system comprising:
a sensor configured to monitor an environment outside a vehicle; and
a controller configured to recognize an oncoming traveling object through the sensor, derive a width of a travelable road between the traveling object and the vehicle, determine priority between the traveling object and the vehicle when the width of the travelable road is smaller than a sum of widths of the traveling object and the vehicle, and, when the traveling object is determined to have the priority, control traveling of the vehicle to provide a space in a lateral direction of the vehicle to allow the traveling object to pass.

2. The vehicle driving system of claim 1, wherein the controller is configured to derive an expected collision site of the vehicle and the traveling object, and determine that one of the vehicle and the traveling object, which requires a less time to reach the expected collision site, has the priority.

3. The vehicle driving system of claim 1, wherein the controller is configured to derive a time to collision (TTC) between the vehicle and the traveling object, and when the TTC is less than a reference value, determine that one of the vehicle and the traveling object, which has a higher speed or higher acceleration, has the priority.

4. The vehicle driving system of claim 1, wherein the controller is configured to derive an expected collision site of the vehicle and the traveling object, and determine that one of the vehicle and the traveling object, which first passes through one of two sites spaced a predetermined distance apart from the expected collision site and facing each other, has the priority.

5. The vehicle driving system of claim 1, wherein the controller is configured to determine that the traveling object has the priority when the traveling object is recognized as having an intention to travel.

6. The vehicle driving system of claim 5, wherein the controller is configured to recognize, when the traveling object does not decelerate, the traveling object as having an intention to travel.

7. The vehicle driving system of claim 5, wherein the controller is configured to recognize the traveling object as having an intention to travel, when a rate of change in a forward heading angle of the traveling object is less than a reference value.

8. The vehicle driving system of claim 5, wherein the controller is configured to recognize the traveling object as having an intention to travel, when the traveling object does not make way for a predetermined time in a situation in which the vehicle and the traveling object stop.

9. A method performed by a vehicle driving system for controlling a vehicle, the method comprising:
recognizing, by a sensor, an oncoming traveling object;
deriving, by a controller, a width of a travelable road between the traveling object and a vehicle;
determining, by the controller, priority between the traveling object and the vehicle when the width of the travelable road is smaller than a sum of widths of the traveling object and the vehicle; and
controlling, by the controller, when the traveling object is determined to have the priority, traveling of the vehicle to provide a space in a lateral direction of the vehicle to allow the traveling object to pass.

10. The method of claim 9, wherein, in the determining of priority,
an expected collision site of the vehicle and the traveling object is derived, and one of the vehicle and the traveling object, which requires a less time to reach the expected collision site, is determined to have the priority.

11. The method of claim 9, further comprising, after the determining of priority, determining, by a controller, whether the traveling object has an intention to travel,
wherein the traveling object is determined to have the priority when the traveling object is recognized as having an intention to travel.
